(19) United States
(12) Patent Application Publication
(10) Pub. No.: US 2025/0295171 A1
(43) Pub. Date: Sep. 25, 2025

(54) HEATING MODULE AND AEROSOL GENERATING APPARATUS

(71) Applicant: SHENZHEN FIRST UNION TECHNOLOGY CO., LTD., Shenzhen, Guangdong (CN)

(72) Inventors: Zuqiang QI, Shenzhen, Guangdong (CN); Jiamao LUO, Shenzhen, Guangdong (CN); Guimin CHEN, Shenzhen, Guangdong (CN); Shiquan XIANG, Shenzhen, Guangdong (CN); Xinlei LI, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/861,790

(22) PCT Filed: Apr. 26, 2023
(86) PCT No.: PCT/CN2023/090909

§ 371 Date: Oct. 30, 2024

(30) Foreign Application Priority Data
Apr. 30, 2022 (CN) 202221035011.X

(51) Int. Cl. A24F 40/46; A24F 40/57; H05B 3/03

(52) U.S. Cl. CPC A24F 40/46; A24F 40/57; H05B 3/03

(57) ABSTRACT

A heating module and an aerosol generating apparatus are provided. The heating module includes a tubular base body and a heater. An accommodation cavity is formed inside the tubular base body. A part of the accommodation cavity is configured to accommodate an aerosol-generating product. A part of the accommodation cavity is configured to accommodate a porous body. Air enters the aerosol-generating product after passing through a pore inside the porous body. The heater is arranged on a side surface of the tubular base body. The heater includes a first heating region and a second heating region. The first heating region is correspondingly arranged on a periphery of the aerosol-generating product and is configured to heat or maintain a temperature of the aerosol-generating product. The second heating region is correspondingly arranged on a periphery of the porous body and is configured to heat the porous body.

### CROSS-REFERENCE TO RELATED APPLICATIONS

This application claims priority to Chinese Patent Application No. 202221035011.X, filed with the China National Intellectual Property Administration on Apr. 30, 2022 and entitled “HEATING MODULE AND AEROSOL GENERATING APPARATUS”, which is incorporated herein by reference in its entirety.

### TECHNICAL FIELD

Embodiments of this application relate to the field of aerosol generation technologies, and in particular, to a heating module and an aerosol generating apparatus.

### BACKGROUND

An existing aerosol generating apparatus generally includes a heater, and the heater heats an aerosol-generating product to cause the aerosol-generating product to generate an aerosol.

In some aerosol generating apparatuses, the heater is a porous body. The porous body may heat air entering the aerosol-generating product to form hot air. By using fluidity of air, after entering the aerosol-generating product, the hot air can be evenly distributed in the aerosol-generating product, so that the aerosol-generating product can be evenly baked.

However, when the hot air flows inside an aerosol-generating product, a temperature of the hot air falls quickly due to heat exchange with the aerosol-generating product. As a result, at least a downstream part of the aerosol-generating product cannot be fully baked.

### SUMMARY

Embodiments of this application provides a heating module and an aerosol generating apparatus. A second heating region heats flowing air through a porous body, and a first heating region may heat or maintain a temperature of an aerosol-generating product in a first accommodation cavity, so that a temperature of air inside the aerosol-generating product can be prevented from falling, and this helps to provide an effect of heating the aerosol-generating product.

An embodiment of this application provides a heating module, including:
a tubular base body, where an accommodation cavity is formed inside the tubular base body, a part of the accommodation cavity is configured to accommodate an aerosol-generating product, and a part of the accommodation cavity is configured to accommodate a porous body; and
air enters the aerosol-generating product after passing through a pore inside the porous body; and
a heater, arranged on a side surface of the tubular base body, where the heater includes a first heating region and a second heating region, the first heating region is correspondingly arranged on a periphery of the aerosol-generating product and is configured to heat or maintain a temperature of the aerosol-generating product, and the second heating region is correspondingly arranged on a periphery of the porous body and is configured to heat the porous body.

An embodiment of this application provides an aerosol generating apparatus, including the heating module.

According to the foregoing heating module and the aerosol generating apparatus, the first heating region heats or maintains the temperature of the aerosol-generating product in the accommodation cavity, and the second heating region heats the porous body in the accommodation cavity, thereby heating air flowing through an inner part of the porous body to form hot air to enter the aerosol-generating product. Through a design of the first heating region and the second heating region, a cooling rate of the hot air in the aerosol-generating product can be slowed down, so that the aerosol-generating product can be fully heated by the hot air, so that the aerosol-generating product can be fully used, and the aerosol-generating product can be prevented from being wasted. In addition, the aerosol generated by the aerosol-generating product can be prevented from clogging the aerosol-generating product due to condensing in the aerosol-generating product. In addition, the heater is arranged on only the tubular base body. This satisfies that air heating is implemented on the aerosol-generating product through the porous body, and the aerosol-generating product can be heated or the temperature of the aerosol-generating product can be maintained through heat transfer or radiation, so that there is no need to arrange a heating circuit on the porous body, to electrically connect the porous body to a conductive element such as a wire, and to add an auxiliary element for heating of the porous body. In this way, a structure is simple, and this helps to keep the porous body inside the tubular base body.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a schematic diagram of an aerosol generating apparatus according to an embodiment of this application;

FIG. 2 is a schematic diagram of a heating module according to an embodiment of this application;

FIG. 3 is another schematic diagram of a heating module according to an embodiment of this application;

FIG. 4 is a schematic exploded view of a heating module according to another embodiment of this application; and

FIG. 5 is a schematic diagram of a heating module according to another embodiment of this application.

In the drawings:
1. aerosol-generating product;
2. heating module; 21. tubular base body; 211. first accommodation cavity; 22. porous body; 23. heater; 231. first heating region; 232. second heating region; 24. common electrode; 241. wide portion; 242. narrow portion; 251. first electrode; 252. second electrode; 253. third electrode;
3. power supply assembly; 31. core; and 32. controller.

### DETAILED DESCRIPTION

The following clearly and completely describes the technical solutions in embodiments of this application with reference to the accompanying drawings in the embodiments of this application. Apparently, the described embodiments are merely some but not all of the embodiments of this application. All other embodiments obtained by a person of ordinary skill in the art based on the embodiments of this application without creative efforts shall fall within the protection scope of this application.

The terms “first”, “second”, and “third” in this application are used for descriptive purposes only and should not be construed as indicating or implying relative importance or implicitly indicating the number or sequence of indicated technical features. All directional indications (such as up, down, left, right, front, and back) in the embodiments of this application are only used for explaining relative position relationships, movement situations, or the like between components in a specific posture (as shown in the accompanying drawings). If the specific posture changes, the directional indications change accordingly. In addition, terms “comprise”, “have”, and any variations thereof are intended to indicate non-exclusive inclusion. For example, a process, method, system, product, or device that includes a series of steps or units is not limited to the listed steps or units; and instead, further optionally includes a step or unit that is not listed, or further optionally includes another step or unit that is intrinsic to the process, method, product, or device.

“Embodiment” mentioned in the specification means that particular features, structures, or characteristics described with reference to the embodiment may be included in at least one embodiment of this application. The term appearing at different positions of the specification may not refer to the same embodiment or an independent or alternative embodiment that is mutually exclusive with another embodiment. A person skilled in the art explicitly or implicitly understands that the embodiments described in the specification may be combined with other embodiments.

It should be noted that, when a component is referred to as “being fixed to” another component, the component may be directly on the another component, or an intervening component may be present. When a component is considered to be “connected to” another component, the component may be directly connected to the another component, or one or more intervening components may also be present. The terms “vertical”, “horizontal”, “left”, and “right”, and similar expressions used in this specification are only for the purpose of description but not indicate a unique implementation.

An embodiment of this application provides an aerosol generating apparatus. The apparatus may be configured to heat an aerosol-generating product to evaporate the aerosol-generating product into an aerosol for inhalation. The aerosol may include Chinese herbal medicine, nicotine, or a flavor substance such as a tobacco flavor.

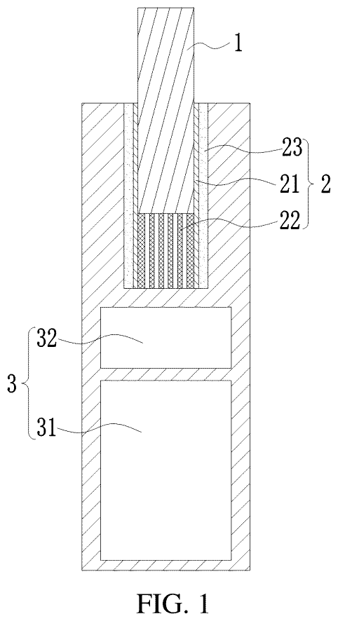

In an embodiment shown in FIG. 1, an aerosol generating apparatus includes a receiving cavity configured to receive an aerosol-generating product 1 and a heating module 2 configured to heat the aerosol-generating product, and further includes a power supply assembly 3. The power supply assembly 3 is configured to provide power for working of the heating module 2.

Referring to FIG. 1, the aerosol generating apparatus has an insertion port, and the aerosol-generating product 1, for example, a cigarette, may be removably received in the receiving cavity through the insertion port. At least a part of the heating module 2 longitudinally extends in the receiving cavity, and heats up in a variable magnetic field through electromagnetic induction, or heats up through a resistor when energized, or radiates an infrared ray to the aerosol-generating product when stimulated, thereby heating the aerosol-generating product 1, for example, the cigarette, to evaporate at least one component of the aerosol-generating product 1, to form an aerosol for inhalation. The power supply assembly 3 includes a core 31. The core 31 is a rechargeable direct current core, and can output a direct current. In another embodiment, the core 31 may alternatively be a disposable battery that is not rechargeable or does not need to be charged. In another embodiment, the power supply assembly 3 may be a wired power supply, and the wired power supply is directly connected to mains electricity through a plug to provide power for the aerosol generating apparatus.

In an optional embodiment, a direct-current power supply voltage provided by the core 31 ranges from about 2.5 V to about 9.0 V, and a direct current provided by the core 31 ranges from about 2.5 A to about 20 A.

Power of the power supply assembly 3 may be supplied to the heating module 2 as a pulse signal, and an amount of the power transmitted to the heating module 2 may be adjusted by changing a duty cycle or pulse width or pulse amplitude of a power signal.

In addition, the aerosol generating apparatus further includes a controller 32, and the controller 32 may be arranged on a circuit board. The aerosol generating apparatus includes an insertion detector and a user interface (for example, a graphics display or a combination of LED indicators) for conveying information about the aerosol generating apparatus to a user.

The insertion detector may detect presence and characteristics of the aerosol-generating product close to the heating module 2 on a heat transfer path, and a signal about the presence of the aerosol-generating product 1 is sent to the controller 32. It may be understood that, provision of the insertion detector is optional and not necessary.

The controller 32 controls the user interface to display system information, for example, power of the core 31, a temperature, a status of the aerosol-generating product 1, a puff count, or other information or a combination thereof.

The controller 32 is electrically connected to the core 31 and the heating module 2, to control output of a current, a voltage, or electric power of the heating module 2 by the core 31 or the like.

The controller 32 may include a programmable microprocessor. In another embodiment, the controller 32 may include a dedicated electronic chip, for example, a field programmable gate array (FPGA) or an application-specific integrated circuit (ASIC). Generally, any apparatus that can provide a signal that can control the heating module 2 may be used together with the embodiments discussed in this specification. In an embodiment, the controller 32 is constructed to detect a temperature changing rate of an actual temperature of the heating module 2 relative to a target temperature, to detect an event representing a user puff.

The controller 32 may include a storage assembly, and the storage assembly may include a memory and/or a buffer. The storage assembly may be constructed to record a change of a detected airflow or user puff. The storage assembly may record a puff count or time of each puff of the user. The storage assembly may be further constructed to record a temperature of the heating module 2 and power supplied during each puff. Recorded data may be displayed through the user interface under invoking of the controller 32, or may be output and displayed through another output interface. When the recorded puff count reaches a preset total puff count of the aerosol-generating product 1, the controller 32 may be reset, the controller 32 may zero out the recorded puff count, the controller 32 controls the aerosol generating apparatus to be off, the controller 32 controls the power supply assembly 3 to stop continuing to provide power for the heater, the controller 32 prompts the user, through sound, light, vibration, or the like, that the aerosol-generating product 1 has reached a puff limit, or the like.

User puff data may be used as a basis for subsequent research, apparatus maintenance, and apparatus design. Data of the puff count of the user may be transmitted to an external memory or a processing apparatus through any suitable data output apparatus. For example, the aerosol generating apparatus may include radio and Bluetooth that are connected to the controller 32 or the memory, or a universal serial bus (USB) socket connected to the controller or the memory. Alternatively, the aerosol generating apparatus may be constructed to transmit data from the memory to an external memory in a charging apparatus for the core 31 each time the aerosol generating apparatus is recharged through appropriate data connection.

Further, in an optional embodiment, the aerosol-generating product 1 may be made of a tobacco-containing material releasing a volatile compound from an inhalable product when heated; or may be made of a non-tobacco material that can be suitable for electrically heating smoke generation after being heated. The aerosol-generating product 1 may be made of a solid substrate, including one or more of powder, particles, fragments, strips, or flakes of one or more of herb leaves, tobacco leaves, homogenized tobacco, and expanded tobacco. Alternatively, the aerosol-generating product 1 may include an additional tobacco or non-tobacco volatile flavor compound, to be released when the aerosol-generating product 1 is heated. In some optional embodiments, the aerosol-generating product 1 is prepared in a shape of a conventional cigarette or cigar.

Further, in an optional embodiment, the aerosol-generating product 1 may be included in a smoke generating object. During operation, the smoke generating object including the aerosol-generating product 1 may be completely accommodated in the aerosol generating apparatus. In this case, the user may puff on a mouthpiece of the aerosol generating apparatus. The mouthpiece may be any part of the aerosol generating apparatus that is placed in the mouth of the user for directly inhaling an aerosol generated by the aerosol-generating product 1 or the aerosol generating apparatus. The aerosol is transferred to the mouth of the user through the mouthpiece. Alternatively, during operation, the smoke generating object including the aerosol-generating product 1 may be partially accommodated in the aerosol generating apparatus. In this case, the user may directly puff on a mouthpiece of the smoke generating object.

In an embodiment, reference may be made to FIG. 1 to FIG. 5, and the heating module 2 includes a tubular base body 21, a porous body 22, and a heater 23.

In an embodiment, the tubular base body 21 is made of an insulating material, for example, a PAEK-type material such as PEEK, PEKK, or PEK, or is made of a high-temperature resistant plastic material such as a PI material or a PBI material, or is made of an insulating material such as a ceramic or glass, or at least a surface of the tubular base body 21 is insulated.

In an embodiment, a base material of the tubular base body 21 is a metal tube or a metal sheet, and an insulating layer is arranged on a surface of the metal tube or a surface of the metal sheet, and then the heater 23, an electrode, and the like are arranged on the insulating layer. The metal tube or the metal sheet is made of metal, and therefore has a small specific heat capacity and large heat transfer efficiency, so that energy consumption can be reduced. A thickness of the metal tube or the metal sheet may be any value between 0.03 mm and 0.2 mm, between 0.04 mm and 0.1 mm, between 0.05 mm and 0.1 mm, between 0.05 mm and 0.08 mm, or the like, so that the metal tube or the metal sheet has a small thickness. Therefore, energy consumption of the tubular base body 21 can be further reduced, energy saving can be achieved, and efficiency of heating by the heating module 2 on the aerosol-generating product 1 can be further improved. The insulating layer may be a metal oxidized insulating layer formed by surface oxidation of the metal tube or the metal sheet, or may be an insulating layer formed by coating a slurry made of an insulating material on the surface of the metal tube or the metal sheet.

The tubular base body 21 is roughly tubular, and an accommodation cavity is formed inside the tubular base body 21. The accommodation cavity includes at least a first accommodation cavity 211 and a second accommodation cavity, in other words, the accommodation cavity may be divided into at least two parts, so that at least a part of the accommodation cavity is formed by the first accommodation cavity 211 and the second accommodation cavity (not shown in the figure). The first accommodation cavity 211 and the second accommodation cavity are arranged in parallel in an axial direction and are in communication with each other. The first accommodation cavity 211 is configured to accommodate at least a part of the aerosol-generating product 1, and the second accommodation cavity is configured to accommodate the porous body 22. The porous body 22 has at least one pore for air to pass through. After passing through the porous body 22, the air may enter the first accommodation cavity 211 and then enter the aerosol-generating product 1.

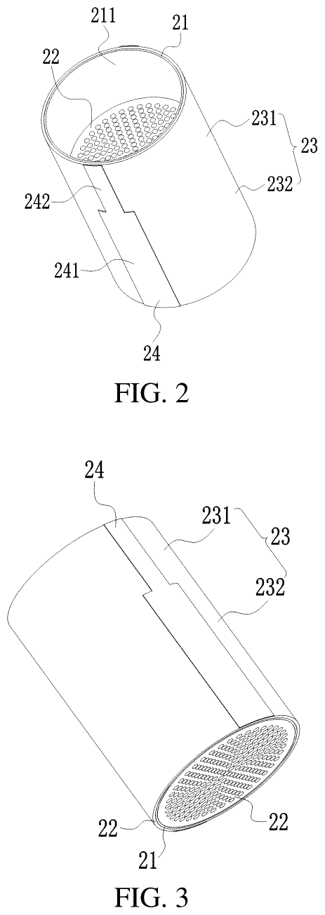

Referring to FIG. 2, FIG. 3, and FIG. 5, the heater 23 is arranged on a side surface of the tubular base body 21, and includes a first heating region 231 and a second heating region 232. Both the first heating region 231 and the second heating region 232 can heat up or emit an infrared ray. The first heating region 232 is arranged on a periphery of the first accommodation cavity 211, and is configured to heat or maintain a temperature of the aerosol-generating product 1 located in the first accommodation cavity 211. The second heating region 232 is arranged on a periphery of the second accommodation cavity, and is configured to heat the porous body 22, so that a temperature of the porous body 22 rises, and then the porous body 22 heats air flowing through a pore therein, to turn the air into hot air. After entering the aerosol-generating product 1, the hot air can evenly bake the aerosol-generating product 1 inside the aerosol-generating product 1, to cause the aerosol-generating product 1 to generate the aerosol.

Because the first heating region 231 is located on the periphery of the first accommodation cavity 211, the first heating region can heat or maintain the temperature of the aerosol-generating product 1 in the first accommodation cavity 211, ensuring that the air and the aerosol in the aerosol-generating product 1 can maintain a high temperature, preventing that the aerosol-generating product 1 cannot be continuously fully baked due to temperature falling caused by a heat exchange between the air and the aerosol-generating product 1. In addition, when flowing in the aerosol-generating product 1, the generated aerosol is prevented from clogging an air hole inside the aerosol-generating product 1 caused by condensing due to a low ambient temperature.

In an optional embodiment, heating power of the second heating region 232 is greater than heating power of the first heating region 231. The second heating region 232 is configured to generate high-temperature air through the porous body 22, and the aerosol-generating product 1 mainly generates the aerosol under baking of the high-temperature air. The second heating region 232 has large heating power, and can quickly heat the porous body 22 to a high temperature, so that the porous body 22 can quickly heat the air flowing therethrough to a preset temperature, so that the aerosol-generating product 1 can quickly generate the aerosol. The first heating region 231 may be mainly configured to maintain the temperature of the aerosol-generating product 1, to ensure that the aerosol-generating product 1 is in a high-temperature environment, thereby reducing a cooling rate and a cooling range of the air and the aerosol inside the aerosol-generating product 1.

The heating power of the first heating region 231 is set to be less than the heating power of the second heating region 232. In this way, overall energy consumption of the heating module 2 can be reduced, and this helps to extend standby duration of the aerosol generating apparatus.

Certainly, it may be understood that, in some embodiments, the first heating region 231 may have larger heating power. In this way, the first heating region 231 can also bake out a volatile from the aerosol-generating product 1, to form the aerosol. In some embodiments, the heating power of the first heating region 231 may be equal to the heating power of the second heating region 232. Alternatively, the heating power of the first heating region 231 may be greater than the heating power of the second heating region 232 in a specific period of time, to improve efficiency of baking the aerosol-generating product 1 and satisfy a requirement of the user for quick smoke emission at a first puff.

In an optional embodiment, the heater 23 is a resistive heater, and heats up through a thermal effect of a resistor.

In an embodiment, the heater 23 may be a heating coil, a mesh, or a metal etching mesh, or the like. The heater is sleeved on an outer side of the tubular base body 21, or is embedded in a side wall of the tubular base body 21, or is arranged on an inner side of the tubular base body 21.

In an embodiment, the heater 23 is a heating film, and the heating film may be a resistive film. The resistive film may be a resistive conductive material such as an iron-chromium-aluminum alloy, a nickel-chromium alloy, a nickel-iron alloy, platinum, tungsten, silver, or a conductive ceramic formed on a side surface of the tubular base body 21 by thick film printing, spraying, vapor deposition, ion implantation, ion sputtering, or the like. Alternatively, the resistive film may be formed in a manner in which a cast film is formed by a resistive conductive material such as an iron-chromium-aluminum alloy, a nickel-chromium alloy, a nickel-iron alloy, platinum, tungsten, silver, or a conductive ceramic by thick film printing, spraying, vapor deposition, ion implantation, ion sputtering, or the like, and then the cast film is coated and sintered on a side surface of the tubular base body 21.

In an embodiment, the heating film may be an infrared film coated on an outer side surface or an inner side surface of the tubular base body 21. The infrared film receives electric power to generate heat, and then generates an infrared ray of a specific wavelength, for example, a far infrared ray of 8 μm to 15 μm. When the wavelength of the infrared ray matches an absorption wavelength of the aerosol-generating product 1, energy of the infrared ray is easily absorbed by the aerosol-generating product. In an implementation of this application, the wavelength of the infrared ray is not limited, and the infrared ray may be an infrared ray of 0.75 μm to 1000 μm, and may optionally be a far infrared ray of 1.5 μm to 400 μm.

In an embodiment, the heating film may alternatively be another flexible film that can heat up, for example, a graphene electric heating film or an FPC electric heating film.

In the embodiments shown in FIG. 2 to FIG. 5, the first heating region 231 and the second heating region 232 are connected in parallel, to have a same working voltage. Therefore, the first heating region 231 and the second heating region 232 may be caused to have different working resistance, to have different heating power.

In an optional embodiment, the heater 23 is a resistive film, a part of the resistive film forms the first heating region 231, and a part of the resistive film forms the second heating region 232. In a direction of a current flowing in each heating region, resistance of the first heating region 231 is greater than resistance of the second heating region 232. R=ρ*L/S, R is the resistance of the resistive film, L is a length of the resistive film in a current direction thereof, ρ is a resistivity of the resistive film, and S is a cross-sectional area of a cross section through which a current passes through the resistive film, where S=w*h, h is a thickness of the cross section, and w is a width of the cross section. Therefore, according to the formula R=ρ*L/S, by changing L and/or S, the first heating region 231 and the second heating region 232 made of a same material can have different resistance R. Certainly, a resistive film of the first heating region 231 and a resistive film of the second region 232 may be made of different materials, to have different resistivities ρ, so that the first heating region 231 and the second heating region 232 that have a same L and a same S have different resistance. In other words, ρ, L, and S may be adjusted, to adjust the resistance of the first heating region 231 and the resistance of the second heating region 232.

In an embodiment, the resistive film of the first heating region 231 and the resistive film of the second heating region 232 are the same, to be specific, ρ is the same. However, an overall thickness of the resistive film is uneven. A thickness of the resistive film of the first heating region 231 is less than that of the resistive film of the second heating region 232. When a length of the first heating region 231 in a current direction and a length of the second heating region 232 in a current direction are consistent or not much different, the resistance (working resistance) of the first heating region 231 is to be greater than the resistance (working resistance) of the second heating region 232. According to a power formula Q=U²/R, Q is heating power, U is a working voltage, and R is working resistance. It can be seen that the heating power of the first heating region 231 with larger resistance is less than the heating power of the second heating region 232.

In an embodiment, as shown in FIG. 2, FIG. 3, and FIG. 5, the resistive film of the first heating region 231 and the resistive film of the second heating region 232 are the same, to be specific, ρ is the same. In addition, the overall thickness of the resistive film is even. The thickness of the resistive film of the first heating region 231 is equal to that of the resistive film of the second heating region 232, but the length of the first heating region 231 in the current direction thereof is greater than the length of the second heating region 232 in the current direction thereof, so that the working resistance of the first heating region 231 is greater than the working resistance of the second heating region 232. When the first heating region 231 and the second heating region 232 have a same working voltage, the heating power of the first heating region 231 with larger resistance is less than the heating power of the second heating region 232.

In the embodiments shown in FIG. 2 to FIG. 4, the heating module 2 further includes a plurality of electrodes, where at least one electrode is a common electrode 24. The common electrode 24 extends in an axial direction of the tubular base body 21, and is electrically connected to both the first heating region 231 and the second heating region 232. The common electrode 24 may be a common negative electrode of the first heating region 231 and the second heating region 232, or may be a common positive electrode of the first heating region 231 and the second heating region 232.

When there is one common electrode 24, both an end of the first heating region 231 and an end of the second heating region 232 are electrically connected to the common electrode 24, and another end of the first heating region 231 and another end of the second heating region 232 are electrically connected to other electrodes respectively.

The common electrode 24 includes a wide portion 241 and a narrow portion 242. A width of the wide portion 241 in a circumferential direction of the tubular base body 21 is greater than a width of the narrow portion 242 in the circumferential direction of the tubular base body 21. The narrow portion 242 is electrically connected to the first heating region 231, and the wide portion 241 is electrically connected to the second heating region 232. Another electrode electrically connected to the first heating region 231 and another electrode electrically connected to the second heating region 232 may have a same circumferential width, so that the first heating region 231 connected to the narrow portion 242 has a greater circumferential length (the length of the heating region described in this application, including the axial length and the circumferential length, refers to a length through which a current flows, and has nothing to do with whether the heating region forms a closed ring) than the second heating region 232 connected to the wide portion 241. A current in the first heating region 231 flows in a circumferential direction of the first heating region, and a current in the second heating region 232 flows in a circumferential direction of the second heating region, so that the working resistance of the first heating region 231 is greater than the working resistance of the second heating region 232.

Certainly, in another embodiment, the another electrode electrically connected to the first heating region 231 and the another electrode electrically connected to the second heating region 232 may have different circumferential widths. For example, a circumferential width of the another electrode electrically connected to the first heating region 231 is less than a circumferential width of the another electrode electrically connected to the second heating region 232. In another embodiment, each location on the common electrode 24 has a same circumferential width. However, the circumferential width of the another electrode electrically connected to the first heating region 231 is less than the circumferential width of the another electrode electrically connected to the second heating region 232. No matter how a width of each location on each electrode is set, as long as a spacing between electrodes at both ends of the first heating region 231 is greater than a spacing between electrodes at both ends of the second heating region 232, it can be achieved that under the premise of the same thickness and material of the heating film, the working resistance of the first heating region 231 is greater than the working resistance of the second heating region 232, so that when the first heating region 231 and the second heating region 232 have a same working voltage, the heating power of the first heating region 231 is less than the heating power of the second heating region 232.

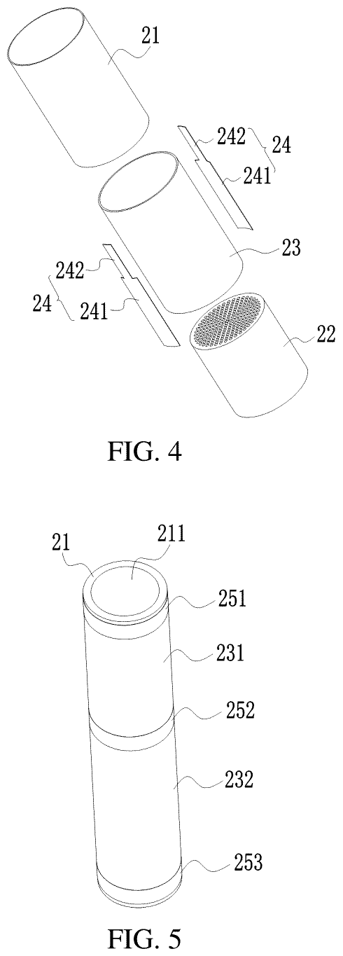

In an embodiment, referring to FIG. 4, the common electrode 24 includes two common electrodes, a common positive electrode and a common negative electrode respectively. Both an end of the first heating region 231 and an end of the second heating region 232 are electrically connected to one common electrode 24, and both another end of the first heating region 231 and another end of the second heating region 232 are electrically connected to the other common electrode 24.

Optionally, one common electrode 24 includes a wide portion 241 and a narrow portion 242. Each location of the other common electrode 24 has a same circumferential width. The narrow portion 242 is electrically connected to the first heating region 231, and the wide portion 241 is electrically connected to the second heating region 232. In this way, the first heating region 231 connected to the narrow portion 242 has a greater circumferential length (a length through which a current flows) than the second heating region 232 connected to the wide portion 241. A current in the first heating region 231 flows in a circumferential direction of the first heating region, and a current in the second heating region 232 flows in a circumferential direction of the second heating region, so that the working resistance of the first heating region 231 is greater than the working resistance of the second heating region 232.

Optionally, each of the two common electrodes 24 (namely, the common positive electrode and the common negative electrode) includes a wide portion 241 and a narrow portion 242. The two narrow portions 242 are electrically connected to the first heating region 231, and the two wide portions 241 are electrically connected to the second heating region 232. In this way, the first heating region 231 connected to the two narrow portions 242 has a greater circumferential length (a length through which a current flows) than the second heating region 232 connected to the two wide portions 241. A current in the first heating region 231 flows in a circumferential direction of the first heating region, and a current in the second heating region 232 flows in a circumferential direction of the second heating region, so that the working resistance of the first heating region 231 is greater than the working resistance of the second heating region 232.

An end of the first heating region 231 is electrically connected to the narrow portion 242 of the common positive electrode, and another end is electrically connected to the narrow portion 242 of the common negative electrode. An end of the second heating region 232 is electrically connected to the wide portion 241 of the common positive electrode, and another end is electrically connected to the wide portion 241 of the common negative electrode. In this way, a length difference between a circumferential length of the first heating region 231 connected to the narrow portions 242 and a circumferential length of the second heating region 232 connected to the wide portions 241 is further enlarged, so that resistance of the first heating region 231 between the two narrow portions 242 is further greater than resistance of the second heating region 232 between the two wide portions 241. When the first heating region 231 and the second heating region 232 have a same working voltage, the heating power of the first heating region 231 with greater resistance is further less than the heating power of the second heating region 232.

Optionally, each of the two common electrodes 24 (namely, the common positive electrode and the common negative electrode) includes a first portion and a second portion. The two first portions are electrically connected to the first heating region 231, and the two second portions are electrically connected to the second heating region 232. In addition, a current flows from one first portion to the other first portion through the first heating region 231, and a current flows from one second portion to the other second portion through the second heating region 232. In addition, a length through which the current flows between the two first portions is greater than a length through which the current flows between the two second portions, and the working resistance of the first heating region 231 is greater than that of the second heating region 232.

The first heating region 231 and the second heating region 232 are located between the common positive electrode and the common negative electrode, so that the first heating region 231 and the second heating region 232 have a same working voltage.

Further, referring to FIG. 2 and FIG. 3, the resistive film is continuous and uninterrupted the axial direction of the tubular base body 21, and the resistive film is divided by the common electrodes 24 into two parallel parts, a left part and a right part respectively, in the circumferential direction of the tubular base body 21. Each of the left part and the right part includes the first heating region 231 and the second heating region 232. Certainly, it may be understood that, the resistive film may alternatively be intermittently arranged on the side surface of the tubular base body 21. For example, the resistive film may be intermittently divided into two parts, the first heating region 231 and the second heating region 232 respectively.

In the embodiment shown in FIG. 5, the heater 23 is a resistive film, a part of the resistive film forms the first heating region 231, and a part of the resistive film forms the second heating region 232. A current flows in an axial direction of the first heating region 231 and the second heating region 232, and an axial length of the first heating region 231 is greater than an axial length of the second heating region 232. The resistive film covers the side surface of the tubular base body 21 with an even thickness, in other words, the first heating region 231 and the second heating region 232 have a same thickness. In this way, the working resistance of the first heating region 231 is greater than the working resistance of the second heating region 232, so that when the first heating region 231 and the second heating region 232 have a same working voltage, the heating power of the first heating region 231 with greater resistance is further less than the heating power of the second heating region 232.

Referring to FIG. 5, the heater 23 further includes a first electrode 251, a second electrode 252, and a third electrode 253 that extend in the circumferential direction of the tubular base body 21, the first electrode 251 is electrically connected to the first heating region 231, the third electrode 253 is electrically connected to the second heating region 232, and the second electrode 252 is electrically connected to both the first heating region 231 and the second heating region 232. Referring to FIG. 5, the second electrode 252 is located between the first electrode 251 and the third electrode 253.

Optionally, the first electrode 251 and the third electrode 253 are negative electrodes, and the second electrode 252 is a positive electrode and forms a common positive electrode of the first heating region 231 and the second heating region 232. Because the second electrode 252 is a common positive electrode, the first heating region 231 between the first electrode 251 and the second electrode 252 and the second heating region 232 between the second electrode 252 and the third electrode 253 have a same working voltage.

Optionally, one of the first electrode 251 and second electrode 252 is selected as a negative electrode, and the third electrode 253 is a positive electrode and forms a common positive electrode of the first heating region 231 and second heating region 232. The controller 32 controls that only one of the first electrode 251 and the second electrode 252 can be selected to be connected to the third electrode 253. When the controller 32 controls the second electrode 252 to be connected to the third electrode 253, the second heating region 232 heats up, and the first heating region 231 is vacant and does not participate in heating. When the controller 32 controls the first electrode 251 to be connected to the third electrode 253, both the first heating region 231 and the second heating region 232 heat up.

In a case that a potential difference U between the positive electrode and the negative electrode is the same, and only the second heating region 232 heats up, heating power Q1=U²/R2. U is the potential difference between the positive electrode and the negative electrode, and R2 is resistance of the second heating region. When both the first heating region 231 and the second heating region 232 heat up, heating power Q2=U^{2/}(R1+R2). R1 is resistance of the first heating region, and it can be seen that Q1>Q2. Therefore, the controller 32 may control the third electrode 253 to be connected to the first electrode 251 and the second electrode 252 in turn.

When the heater includes an electrode and a heating film arranged on the side surface of the tubular base body, the electrode covers a surface of the heating film. For example, the heating film is formed on the side surface of the tubular base body 21 by thick film printing, spraying, vapor deposition, ion implantation, ion sputtering, or the like, and surrounds the tubular base body 21 in a 360° manner, and the electrode is formed on the surface of the heating film by thick film printing, spraying, vapor deposition, ion implantation, ion sputtering, or the like. Resistance of the electrode is far less than resistance of the heating film, so that almost no current flows through the heating film overlapping the electrode.

In an embodiment, at least one of the first heating region and the second heating region heats up through magnetic induction, to be specific, at least one of the first heating region and the second heating region contains grade 430 stainless steel (SS430), grade 420 stainless steel (SS420), or another magnetically inductive material such as an iron-nickel alloy material (such as Permalloy) that can heat up in a variable magnetic field, thereby being able to spontaneously heat up in a variable magnetic field due to generation of an eddy current and magnetic hysteresis. Correspondingly, the aerosol generating apparatus further includes a magnetic field generator, for example, an induction coil, configured to generate a variable magnetic field under an alternating current. In addition, the circuit board connects the core 31 and the induction coil, and may convert a direct current output by the core 31 into an alternating current, and optionally, a frequency of the alternating current is between 80 KHz and 400 KHz. More specifically, the frequency may be in a range of approximately 200 KHz to 300 KHz.

When both the first heating region 231 and the second heating region 232 heat up through magnetic induction, different materials may be used for the first heating region 231 and the second heating region 232, to cause the first heating region 231 and the second heating region 232 to have different heating efficiency. Alternatively, the induction coil may be caused to provide variable magnetic fields of different strength for the first heating region 231 and the second heating region 232, to cause the first heating region 231 and the second heating region 232 to have different heating efficiency. In this case, the induction coil may be one or more induction coils.

In an embodiment, the controller 32 is electrically connected to the heating module 2 and the power supply assembly 3. The controller 32 may control the power supply assembly 3 to provide different working voltages, working voltages with different duty cycles, variable magnetic fields with different magnetic field strength or changing frequencies, or the like for the first heating region 231 and the second heating region 232, to cause the first heating region 231 and the second heating region 232 to have different heating efficiency. For example, heating efficiency of the first heating region 231 is caused to be less than heating efficiency of the second heating region 232.

In an embodiment, referring to FIG. 2 to FIG. 4, the porous body 22 is a glass fiber with a plurality of pores. Compared with a cellular ceramic, a cellular glass fiber may have denser air holes, so that air can be heated more fully and quickly. In an embodiment, the porous body 22 is a cellular structure made of a carbon material. The carbon material may be graphite, graphene, a graphite alloy, or another carbon material. An advantage of using the carbon material to make the cellular structure is that the carbon material has a higher thermal conductivity than a ceramic, a glass fiber, or the like, and the thermal conductivity thereof may be as high as 129 W/(m·K). In an embodiment, the porous body 22 is made of metal foam, such as silver foam or titanium foam. A characteristic of a metal foam material includes: (1) Light weight and low specific gravity: The metal foam is a mixture of metal and gas, and a specific gravity is only 1/50 to ⅗ of that of metal of a same volume. (2) High porosity: A porosity of general porous metal foam is 40% to 90%, while a porosity of a sponge-like foamed metal material may be as high as 98%. (3) Large specific surface area: A specific surface area of the metal foam may reach 10 to 40 cm²/cm³. (4) Large pore size range: Through process control, an obtainable pore size ranges from a micrometer level to a centimeter level. By using a property of the metal foam, efficiency of heating flowing air may be improved.

According to the foregoing heating module and the aerosol generating apparatus, the first heating region heats or maintains the temperature of the aerosol-generating product in the accommodation cavity, and the second heating region heats the porous body in the accommodation cavity, thereby heating air flowing through an inner part of the porous body to form hot air to enter the aerosol-generating product. Through a design of the first heating region and the second heating region, a cooling rate of the hot air in the aerosol-generating product can be slowed down, so that the aerosol-generating product can be fully heated by the hot air, so that the aerosol-generating product can be fully used, and the aerosol-generating product can be prevented from being wasted. In addition, the aerosol generated by the aerosol-generating product can be prevented from clogging the aerosol-generating product due to condensing in the aerosol-generating product. In addition, the heater is arranged on only the tubular base body. This satisfies that air heating is implemented on the aerosol-generating product through the porous body, and the aerosol-generating product can be heated or the temperature of the aerosol-generating product can be maintained through heat transfer or radiation, so that there is no need to arrange a heating circuit on the porous body, to electrically connect the porous body to a conductive element such as a wire, and to add an auxiliary element for heating of the porous body. In this way, a structure is simple, and this helps to keep the porous body inside the tubular base body.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing description, and all the improvements and modifications shall fall within the protection scope of the attached claims of this application.

1. A heating module configured to heat an aerosol-generating product, comprising:
a tubular base body, wherein an accommodation cavity is formed inside the tubular base body, a part of the accommodation cavity is configured to accommodate the aerosol-generating product, and a part of the accommodation cavity is configured to accommodate a porous body, wherein air enters the aerosol-generating product after passing through a pore inside the porous body; and
a heater arranged on a side surface of the tubular base body, wherein the heater comprises a first heating region and a second heating region, the first heating region is correspondingly arranged on a periphery of the aerosol-generating product and is configured to heat or maintain a temperature of the aerosol-generating product, and the second heating region is correspondingly arranged on a periphery of the porous body and is configured to heat the porous body.

2. The heating module according to claim 1, wherein heating power of the second heating region is greater than heating power of the first heating region.

3. The heating module according to claim 1, wherein the first heating region and the second heating region are connected in parallel, to have a same working voltage.

4. The heating module according to claim 1, wherein the heater comprises a resistive heater, and resistance of the first heating region is greater than resistance of the second heating region in a direction in which a current flows.

5. The heating module according to claim 4, wherein:
the resistive heater comprises a resistive film;
a part of the resistive film forms the first heating region, a part of the resistive film forms the second heating region;
both a current in the first heating region and a current in the second heating region circumferentially flow; and
a circumferential length of the first heating region is greater than a circumferential length of the second heating region; or a thickness of the first heating region is less than a thickness of the second heating region.

6. The heating module according to claim 5, wherein:
the heater further comprises a common electrode, and the common electrode extends in an axial direction of the tubular base body and is electrically connected to both the first heating region and the second heating region;
the common electrode comprises a wide portion and a narrow portion, and a circumferential width of the wide portion is greater than a circumferential width of the narrow portion; and
the narrow portion is electrically connected to the first heating region, and the wide portion is electrically connected to the second heating region.

7. The heating module according to claim 5, wherein:
the heater further comprises two common electrodes, respectively a common positive electrode and a common negative electrode;
each of the two common electrodes extends in an axial direction of the tubular base body and is electrically connected to both the first heating region and the second heating region; and
each location of one common electrode has a same width in a circumferential direction of the tubular base body, the other common electrode comprises a wide portion and a narrow portion, a width of the wide portion in the circumferential direction of the tubular base body is greater than a width of the narrow portion in the circumferential direction of the tubular base body, the narrow portion is electrically connected to the first heating region, and the wide portion is electrically connected to the second heating region.

8. The heating module according to claim 7, wherein:
the resistive film is continuous in the axial direction of the tubular base body;
the resistive film is divided by the two common electrodes into two parallel parts in the circumferential direction of the tubular base body; and
each part comprises the first heating region and the second heating region.

9. The heating module according to claim 4, wherein:
the resistive heater is a resistive film, a part of the resistive film forms the first heating region, a part of the resistive film forms the second heating region, and a current flows in an axial direction of the first heating region and the second heating region; and
an axial length of the first heating region is greater than an axial length of the second heating region; or a thickness of the first heating region is less than a thickness of the second heating region.

10. The heating module according to claim 9, wherein:
the heater further comprises a first electrode, a second electrode, and a third electrode that extend in a circumferential direction of the tubular base body;
the first electrode is electrically connected to the first heating region, the third electrode is electrically connected to the second heating region, and the second electrode is electrically connected to both the first heating region and the second heating region; and
the first electrode and the third electrode are negative electrodes, and the second electrode is a positive electrode and forms a common positive electrode of the first heating region and the second heating region.

11. The heating module according to claim 4, wherein:
the heater further comprises a first electrode, a second electrode, and a third electrode that extend in a circumferential direction of the tubular base body;
the first electrode is electrically connected to the first heating region, the third electrode is electrically connected to the second heating region, and the second electrode is electrically connected to both the first heating region and the second heating region; and
one of the first electrode and the second electrode is selected as a negative electrode, and the third electrode is a positive electrode and forms a common positive electrode of the first heating region and the second heating region.

12. The heating module according to claim 1, wherein the heater is arranged on an outer side surface of the tubular base body.

13. The heating module according to claim 1, wherein:
the porous body is a glass fiber with a plurality of pores; or
the porous body is a cellular structure made of a carbon material or the porous body is made of metal foam.

14. The heating module according to claim 1, wherein:
the heater comprises: a resistive film or an infrared film arranged on the side surface of the tubular base body, and an electrode; and
the electrode covers a surface of the resistive film or the infrared film, to be electrically connected to the resistive film or the infrared film.

15. The heating module according to claim 1, wherein at least one of the first heating region and the second heating region heats up through magnetic induction, or heats up through a thermal effect of a resistor, or is configured to radiate an infrared ray to the accommodation cavity.

16. A heating module configured to heat an aerosol-generating product, comprising:
a tubular base body, wherein an accommodation cavity is formed inside the tubular base body, a part of the accommodation cavity is configured to accommodate the aerosol-generating product, and a part of the accommodation cavity is configured to accommodate a porous body, wherein air enters the aerosol-generating product after passing through a pore inside the porous body; and
a heater comprising a heating film arranged on a side surface of the tubular base body and an electrode electrically connected to the heating film,
wherein:
a part of the heating film forms a first heating region, a part of the heating film forms a second heating region, the first heating region is correspondingly arranged on a periphery of the aerosol-generating product and is configured to heat or maintain a temperature of the aerosol-generating product, and the second heating region is correspondingly arranged on a periphery of the porous body and is configured to heat the porous body;
two electrodes are provided, and are both electrically connected to the first heating region and the second heating region, each of the two electrodes comprises a second portion and a first portion, two first portions are electrically connected to the first heating region, and two second portions are electrically connected to the second heating region; and
a spacing between the two first portions in a circumferential direction of the tubular base body is greater than a spacing between the two second portions in the circumferential direction of the tubular base body.

17. An aerosol generating apparatus comprising the heating module according to claim 1.

18. The aerosol generating apparatus according to claim 17, wherein:
the aerosol generating apparatus further comprises a power supply assembly and a controller; and
the controller is electrically connected to the heating module and the power supply assembly, to control the heating power of the second heating region to be greater than the heating power of the first heating region.

19. The heating module according to claim 5, wherein:
the heater further comprises two common electrodes, respectively a common positive electrode and a common negative electrode;
each of the two common electrodes extends in an axial direction of the tubular base body and is electrically connected to both the first heating region and the second heating region; and
each of the two common electrodes comprises a wide portion and a narrow portion, and a width of the wide portion in a circumferential direction of the tubular base body is greater than a width of the narrow portion in the circumferential direction of the tubular base body, two narrow portions are electrically connected to the first heating region, and two wide portions are electrically connected to the second heating region.

20. The heating module according to claim 5, wherein:
the heater further comprises two common electrodes, respectively a common positive electrode and a common negative electrode;
each of the two common electrodes extends in an axial direction of the tubular base body and is electrically connected to both the first heating region and the second heating region; and
each of the two common electrodes comprises a second portion and a first portion, two first portions are electrically connected to the first heating region, and two second portions are electrically connected to the second heating region, wherein a spacing between the two first portions in a circumferential direction of the tubular base body is greater than a spacing between the two second portions in the circumferential direction of the tubular base body.
